(19) United States
(12) Patent Application Publication
(10) Pub. No.: US 2011/0081895 A1
(43) Pub. Date: Apr. 7, 2011

(54) INFORMATION BROWSING SYSTEM

(75) Inventor: Yosuke OHASHI, Tokyo (JP)

(73) Assignee: FUJIFILM Corporation, Tokyo (JP)

(21) Appl. No.: 12/898,602

(22) Filed: Oct. 5, 2010

(30) Foreign Application Priority Data
Oct. 6, 2009 (JP) JP2009-232649

(51) Int. Cl. H04M 3/42

(52) U.S. Cl. 455/414.1

(57) ABSTRACT

At the time when information stored in a server is browsed with the use of a mobile terminal, if the mobile phone is predicted to enter an out-of-service area, information that a user is going to browse is predicted and temporarily stored in the mobile terminal as cache. When the mobile phone is located in a service area at the time of a browse request, information corresponding to the request is acquired from the server, and when the mobile phone is located in an out-of-service area, the information is acquired from the information stored as cache and is displayed. The information stored as cache is deleted when the browsing is ended or when the mobile terminal enters a service area. Therefore, the user can browse desired information even in the out-of-service area with and high security level secured.

### BACKGROUND OF THE INVENTION

1. Field of the Invention

The presently disclosed subject matter relates to an information browsing system, and particularly to an information browsing system for browsing information stored in a server with the use of a mobile terminal.

2. Description of the Related Art

With spread of mobile phones and smart phones in recent years, services that let users securely browse intra-firm e-mails and electronic bulletin boards have been in widespread use. These services are popular for their convenience that allows a user to conduct small tasks during a short vacant time such as traveling time.

However, many of these services ensure security by downloading data from a network every time and letting users browse the data rather than storing data on a mobile terminal, and for that reason the services are not available in places such as subways where network services are interrupted.

In order to solve such a problem, many technical developments relating to data reacquisition at the time of recovery from network service interruption and prediction of network service interruption have been in progress.

Japanese Patent Application Laid-Open No. 2008-199402 discloses a communication system in which in a portable terminal for acquiring data from a server and obtains prescribed data cached from the server beforehand and stores the obtained data as cache data based on the usage prediction of the users, and if information relating to information browsed by the portable terminal is updated during network service interruption, the updated information is sent to the portable terminal after recovery of the network to update the cache.

Japanese Patent Application Laid-Open No. 2004-364223 discloses a mobile communication system in which location information of a mobile terminal is transmitted to an out-of-service notifying server and the out-of-service notifying server transmits an out-of-service notice to the mobile terminal when the destination location of the mobile terminal is predicted to be outside the communication service area based on a map database in the notice server located outside the communication service area.

Japanese Patent Application Laid-Open No. 2007-251840 discloses a mobile terminal device for storing positional information when a state of the mobile terminal device changed into a communication disable state and a time period of the communication disable state and for predicting a position where communication becomes disable based on the information.

### SUMMARY OF THE INVENTION

The invention disclosed in Japanese Patent Application Laid-Open No. 2008-199402 has a problem such that since required information is constantly acquired and stored on the basis of the usage prediction of users, unused information is also stored, which increases communication volume. In addition, information that users wish to obtain is not always information updated at the time of network service interruption, and since the acquired cache remains in the portable terminal, there is a concern of security.

The invention disclosed in Japanese Patent Application Laid-Open No. 2004-364223 predicts whether the mobile terminal will enter an out-of-communication-service area and notifies users of the prediction result, but is not a system that enables users to browse information stored in a server with the mobile terminal. However, a point that the mobile terminal itself does not have to accumulate information on positions where communication is disabled is informative.

The invention disclosed in Japanese Patent Application Laid-Open No. 2007-251840 is relevant in a point of using positional information. However, it would not be practical if the learning of communication disabled positions is insufficient, and for that reason, there is room for improvement in a point of usability of the mobile terminal in places where users visit for the first time.

The presently disclosed subject matter was made in view of these circumstances, and it is an object of the presently disclosed subject matter to provide an information browsing system that allows, when the users browse information stored in a server with the use of a mobile terminal, users to brows desired information even in an out-of-service area and that ensures a high security level by not leaving the browsed information in the mobile terminal.

In order to achieve the object, the presently disclosed subject matter according to claim 1 is an information browsing system including a server for storing information browsed with use of a mobile terminal and the mobile terminal for acquiring desired information from the stored information by communicating with the server, comprising an out-of-service area prediction device for predicting whether the mobile terminal will enter an out-of-service area, a browsing information prediction device for predicting information that a user is going to browse next after the out-of-service area prediction device predicts that the mobile terminal will enter an out-of-service area, an information temporary storage device for acquiring the information predicted by the browsing information prediction device in advance from the server and for temporarily storing the information in the mobile terminal as cache, a browsing request instruction device for instructing a browse request for information that the user is likely to browse, an information acquisition device for acquiring information corresponding to the browse request from the server if the mobile terminal is located in a service area when the browsing request information device issues the browse request, and for acquiring the information corresponding to the browse request from the information temporary storage device if the mobile terminal is located in an out-of-service area, a display device for displaying the information acquired by the information acquisition device; and a temporary information deletion device for deleting the information stored in the information temporary storage device when the mobile terminal enters a service area after the information is stored in the information temporary storage device and the out-of-service area prediction device does not predict that the mobile terminal will enter an out-of-service area.

According to the invention according to the first aspect of the presently disclosed subject matter, when a mobile terminal entering an out-of-service area is predicted, information that a user is likely to browse is predicted and stored temporarily as cache in the mobile terminal. If the mobile terminal is located in a service area at the time of a browse request, information corresponding to the browse request is acquired from a server and if the mobile terminal is located in an out-of-service area, the information corresponding to the browse request is acquired from the information stored as cache and is displayed. As a result, users can continue browsing desired information even in locations such as in subways where the communication state is unstable. Meanwhile, the information stored as cache is deleted when the mobile terminal enters a service area and the mobile terminal is not predicted to enter the out-of-service area. Consequently, a high security level is ensured by not leaving information to be browsed and the browsed information in the mobile terminal.

As described in the second aspect of the presently disclosed subject matter, in the information browsing system of the first aspect of the presently disclosed subject matter, the temporary information deletion device deletes the information stored in the information temporary storage device when the out-of-service area prediction device predicts that the mobile terminal is located in a service area for a prescribed time period or longer.

As described in the third aspect of the presently disclosed subject matter, in the information browsing system of the first or second aspect, the temporary information deletion device preferentially deletes information that a user has browsed when deleting the information stored in the information temporary storage device.

As described in the fourth aspect of the presently disclosed subject matter, in the information browsing system of any of the first to third aspects, the mobile terminal is a mobile phone and communicates with the server via a mobile phone network.

As described in the fifth aspect of the presently disclosed subject matter, in the information browsing system of any of the first to third aspects, the mobile terminal communicate with the server via a wireless LAN.

As described in the sixth aspect of the presently disclosed subject matter, in the information browsing system of any of the first to fifth aspects, the information browsed with use of the mobile terminal is an e-mail, information in a website, or information in an electronic bulletin board. Even if the mobile terminal enters an out-of-service area, users can continue browsing the information.

As described in the seventh aspect of the presently disclosed subject matter, in the information browsing system of any of the first to sixth aspects, the mobile terminal includes a location information acquisition device for acquiring a location of the mobile terminal, and the out-of-service area prediction device includes a map information storage device for storing map information indicating an out-of-service area, and predicts whether the mobile terminal will enter an out-of-service area on the basis of history of the location information acquired by the location information acquisition device and the map information stored in the map information storage device.

For the location information acquisition device, a GPS (Global Positioning System) device mounted on the mobile terminal can be adapted. It is possible to predict whether the mobile terminal will enter an out-of-service area within a prescribed time period from history of location information of the mobile terminal acquired by the location information acquisition device and map information indicating out-of-service areas.

As described in the eighth aspect of the presently disclosed subject matter, in the information browsing system of any of the first to sixth aspects, the out-of-service area prediction device includes a base station location acquisition device for acquiring a location of a base station used when the mobile terminal communicates with a server, and predicts whether the mobile terminal will enter an out-of-service area on the basis of the location of the base station acquired by the base station location acquisition device. The location (place) of the mobile terminal can be detected from the location of the base station communicating with the mobile terminal. For example, when the mobile terminal communicates with a base station installed in a subway station, it can be predicted that the mobile terminal will enter an out-of-service area in the future.

As described in the ninth aspect of the presently disclosed subject matter, in the information browsing system of any of the first to sixth aspects, the out-of-service area prediction device predicts that the mobile terminal will enter an out-of-service area when radio field intensity falls below a preset threshold when the mobile terminal communicates with a server, or when a time period in which the radio field intensity remains below the preset threshold exceeds a certain time period. As described in the tenth aspect of the presently disclosed subject matter, in the information browsing system of any of the first to ninth aspects, the browsing information prediction device predicts information stored in parallel with information that a user is browsing. For example, when a user sequentially browses information included in a list, the information included in the list is predicted as browsing information.

As described in the eleventh aspect of the presently disclosed subject matter, in the information browsing system of any of the first to tenth aspects, the browsing information prediction device predicts information connected to information that a user is browsing. When a user browses information linked to one another, the linked information is predicted as information to be browsed next.

According to the presently disclosed subject matter, when a mobile terminal entering an out-of-service area is predicted, information that a user is going to browse is predicted and stored temporarily as cache in the mobile terminal. If the mobile terminal is located in a service area at the time of a browse request, information corresponding to the browse request is acquired from a server and if the mobile terminal is located in an out-of-service area, the information corresponding to the browse request is acquired from the information stored as cache and is displayed. As a result, users can continue browsing desired information even in an out-of-service area. The information stored as cache is deleted when the mobile terminal enters a service area and the mobile terminal is not predicted to enter the out-of-service area, and for that reason, a high security level is ensured.

### BRIEF DESCRIPTION OF THE DRAWINGS

FIG. 1 is a system configuration diagram illustrating an embodiment of an information browsing system according to the presently disclosed subject matter;

FIG. 2 is a block diagram illustrating an internal configuration of a server constituting the information browsing system;

FIG. 3 is a block diagram illustrating an internal configuration of a mobile terminal (mobile phone) constituting the information browsing system;

FIG. 4 is a flowchart of a portion for temporarily storing information based on information browsing and prediction of out-of-service area by the information browsing system according to the presently disclosed subject matter; and

FIG. 5 is a flowchart relating to deletion of temporary information by means of the information browsing system according to the presently disclosed subject matter.

### DETAILED DESCRIPTION OF THE PREFERRED EMBODIMENTS

In the following description, embodiments of the information browsing system according to the presently disclosed subject matter are explained with reference to the attached drawings.

### [System Configuration]

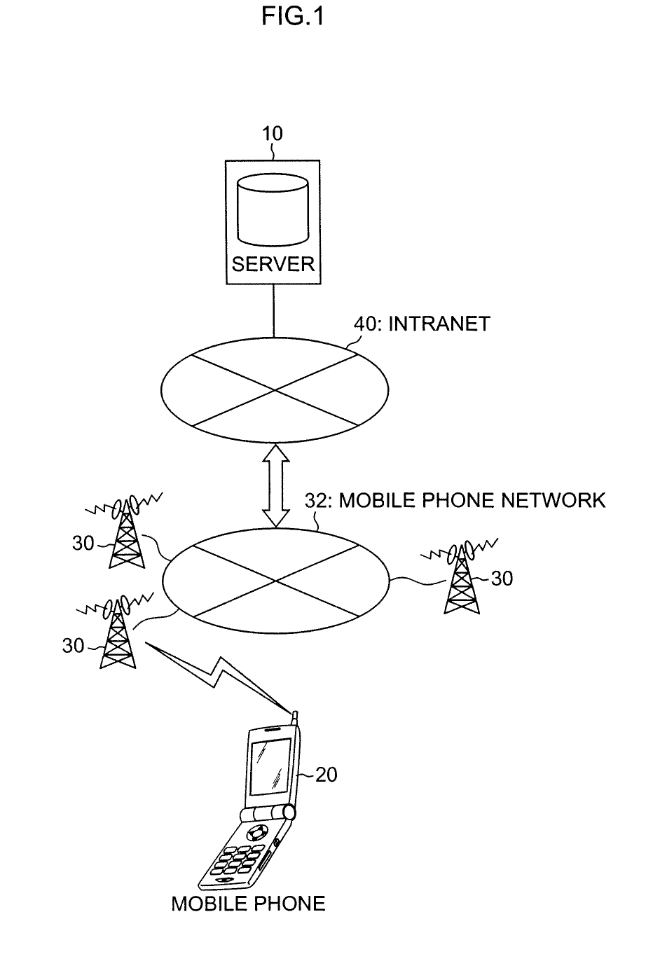

FIG. 1 is a system configuration diagram illustrating the embodiment of the information browsing system according to the presently disclosed subject matter.

This information browsing system mainly includes a server 10 connected to an intranet 40 and a mobile phone 20 of a user, and the mobile phone 20 and the server 10 can be communicated with one another via a base station 30, a mobile phone network 32, a mobile service carrier not shown in the drawing, and the intranet 40.

It should be noted that the server 10 can be connected not only to the intranet 40 but also to other networks such as the Internet. In addition, the present system is applicable not only to the mobile phone 20 but also to mobile terminals such as smart phones, PHS, and personal digital assistance (PDA), and also applicable not only to the mobile phone network 32 but also to communication via wireless LAN.

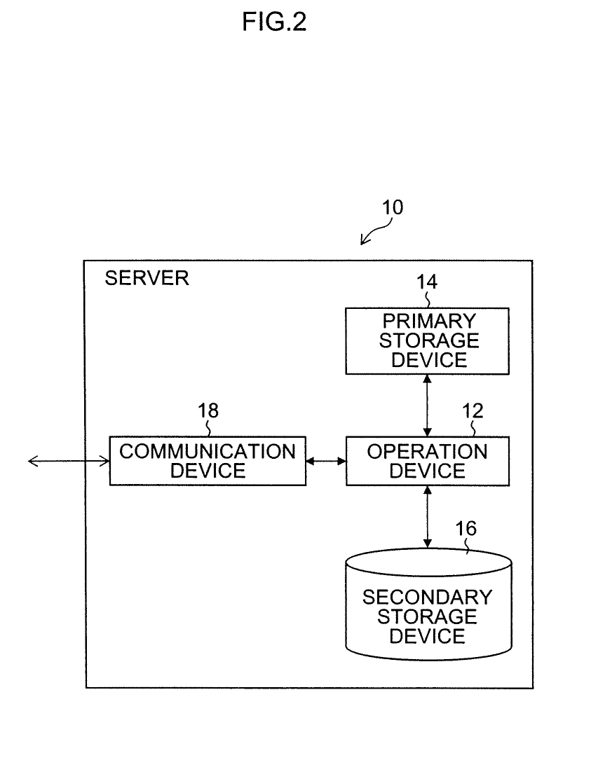

FIG. 2 is a block diagram illustrating an internal configuration of the server 10. As illustrated in FIG. 2, the server 10 mainly includes an operation device 12, a primary storage device 14, a secondary storage device 16, and a communication device 18.

The operation device 12 is a portion where programs such as information delivery operating on servers are operating, and such an operation device 12 can be a CPU or the like. The primary storage device 14 is a region for storing programs executed in the operation device 12, and such a primary storage device can be DRAM (Dynamic RAM) or the like. The secondary storage device 16 is a device in which information browsed by the mobile phone 20 is accumulated, and such a secondary storage device can be HDD (Hard Disk Drive), SSD (Solid State Drive) or the like.

The communication device 18 is a device for communication such as exchanging information between the mobile phone 20 and the server 10, and such a communication device can be a communication device using mobile phone network communication standard (GSM: Global System for Mobile Communications, PDC: Personal Digital Communications, cdmaOne (Code Division Multiple Access-One), Cdma2000, W-CDMA (Wideband-CDMA), GRPS, HSPDA(High Speed Packet Access) and a communication device performing wireless communication (WiFi: Wireless Fidelity, WiMAX: Worldwide Interoperability for Microwave Access).

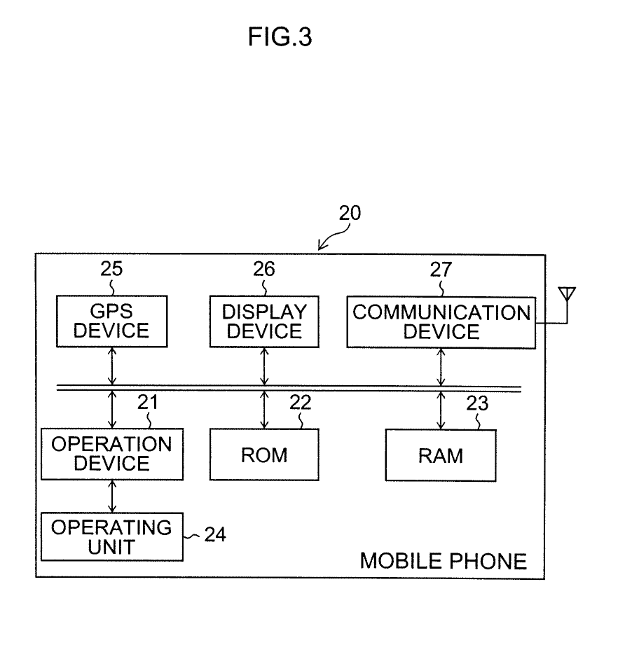

FIG. 3 is a block diagram illustrating an internal configuration of the mobile phone 20.

As illustrated in FIG. 3, the mobile phone 20 mainly includes an operation device 21, read-only memory (ROM)22, random-access memory (RAM), an operating unit 24, a GPS device (Global Positioning System device) 25, a display device 26, and a communication device 27. Although a microphone and a speaker or the like to function as a normal mobile phone are also provided, these portions are omitted in FIG. 3.

The operation device 21 is a portion performing integrated control of the entire mobile phone 20 in accordance with a prescribed control program based on an operating signal input from the operating unit 24, and such an operation device can be a CPU or the like. ROM 22 stores a control program for operating the mobile phone 20, application software for information browsing according to the presently disclosed subject matter, map information indicating out-of-service regions of mobile phones, and others. The operation device 21 performs required operations in accordance with the control program and the application software and controls each device. It should be noted that ROM 22 can be consists of flash ROM, for example, and the above application software, map information and others can be arbitrarily written in or rewritten.

RAM 23 is used as a temporarily storage region for operation work area of the operation device 21 and information that is browsed by using the mobile phone 20.

The operating unit 24 includes a ten-key numerical keypad, multifunctional arrow keys, an Enter key, a cancel key and others.

The GPS device 25 performs positioning of the current location of the mobile phone 20, and acquires GPS information including the current location (latitude, longitude, and altitude) and time. The acquired GPS information is used as information indicating a user's current location on the application software.

The display device 26 consists of a liquid crystal display, and is used as a user interface when various setting operations are performed and as a display for displaying information to be browsed such as texts and images.

The communication device 27 communicates with the server 10 in the other mobile phones or on the intranet 40 by performing wireless communication via the base station 30.

### [Operations of the Present System]

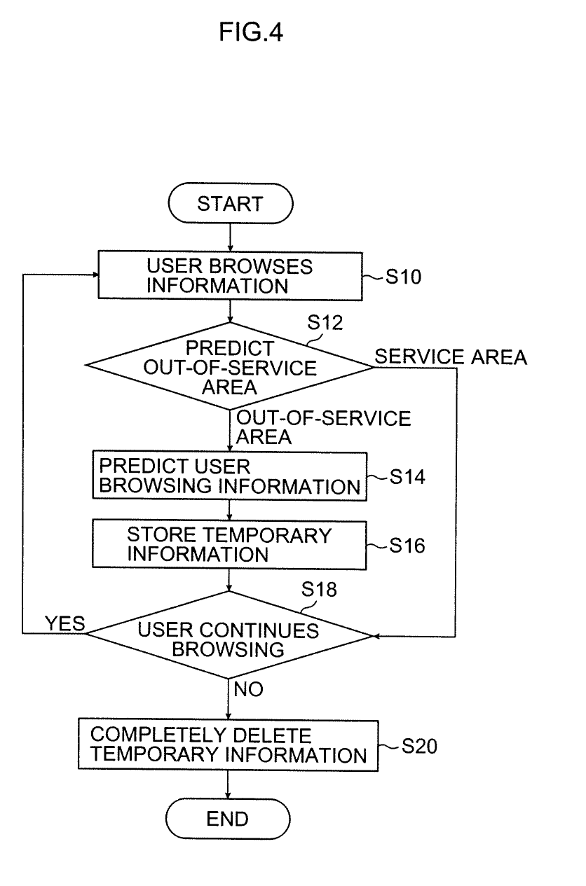

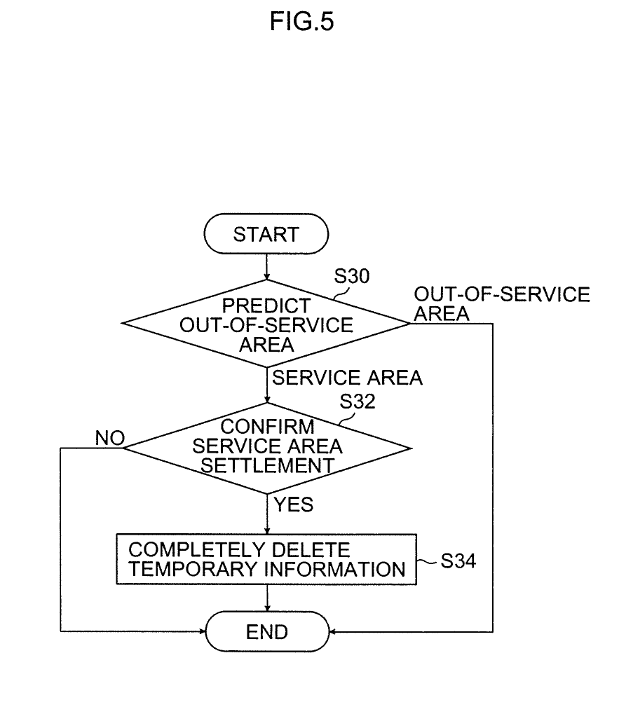

Next, the operations of the present system are explained with reference to FIG. 4 and FIG. 5.

FIG. 4 is a flowchart of a portion for temporary information storage based on information browsing and prediction of out-of-service area by the information browsing system according to the presently disclosed subject matter.

Information Browsing by User (Step S10)

Firstly, information browsing by a user is a basic premise of the processing according the presently disclosed subject matter. The information browsed by a user (company employee etc.) includes various documents and e-mails in a company stored in the secondary storage device 16 of the server 10. It should be noted that besides the documents and e-mails, there can be websites and electronic bulletin boards and others. The information is not limited to these, but can be anything such as still images, moving images, and voices that can be browsed by using a mobile terminal. A prediction method of user browsing information, described later, varies depending on the type of the information.

The server 10 has a function for acquiring documents or the like requested by the mobile phone 20 from the secondary storage device 16 in response to the mobile phone 20 that accessed from the outside of the intranet 40, for converting the documents or the like into a format that can be browsed with the mobile phone 20 (e.g. bitmap data) and for transmitting the documents or the like. With this function, the intra-company documents or the like stored in the secondary storage device 16 in various formats can be browsed from an outside location by using the mobile phone 20.

Out-of-Service Area Prediction (Step S12)

Whether the mobile phone 20 possessed by the user soon enters out-of-service area or not is predicted. The possible cases that the mobile phone 20 enters an out-of-service area are in subways and in depopulated areas. However, there are some prediction methods.

### a) A Case of Using Location Information

For example, whether the mobile phone 20 enters an out-of-service area or not is predicted based on the GPS information acquired from the GPS device 25 provided in the mobile phone 20 and the map information indicating the out-of-service areas stored in ROM 22. When the location of the mobile phone 20 is approaching to an out-of-service area, for example, there is a probability that the mobile phone 20 enters an out-of-service area after a certain time period passes. Therefore, a prediction that the mobile phone 20 enters an out-of-service area can be made. In addition, by obtaining a moving speed and a moving direction from the history of the GPS information, whether the mobile phone 20 enters an out-of-service area or not can be predicted based on a predicted moving location after a certain time period from the current location. In this case, out-of-service prediction with higher accuracy can be made.

### b) A Case of Using Location of Base Station

For example, by using a location where a base station for the mobile phone 20 or for public wireless LAN are installed, whether the mobile phone 20 enters an out-of-service area or not in the future is predicted. More specifically, a possible method is to predict that the mobile phone 20 enters an out-of-service area in the future when the mobile phone 20 communicates with a base station installed in a subway station. Alternatively when most recent locations are repeatedly changed in such a manner as out-of-service area to service area to out-of-service area to service area, it is possible that the mobile phone 20 is on a subway and a prediction can be made that the mobile phone 20 enters an out-of-service area.

### c) A Case of Using Radio Field Intensity

In the above cases a) and b), the out-of-service prediction is performed based on the location of the mobile phone itself or the location information of the base station or the like. This case, however, simply uses radio field intensity in the communication between the mobile phone 20 and the base station, and predicts that the mobile phone 20 enters an out-of-service area when the radio field intensity falls below a threshold. At that time, the prediction of the mobile phone 20 enters an out-of-service area can be made when the time period that the radio field intensity remains below the threshold exceeds a certain time period.

Meanwhile, if a prediction of the mobile phone 20 being in out-of-service area is not made but the mobile phone 20 is in a service area for a certain time period, such a case can be regarded as the mobile phone 20 being in a service area. When the prediction result is “out-of-service area”, the processing shifts to “user browsing information prediction” and the prediction result is “service area”, the processing shifts to “temporarily information deletion”.

User Browsing Information Prediction (Step S14)

The mobile phone 20 (browsing information prediction device) predicts information that the user is likely to browse next from the operations of the information that the user is browsing in “information browsing by user” in step S10. The following prediction methods are possible in accordance with the browsing information.

### a) A Case of Sequentially Browsing Information Included in a List

For example, a case of sequentially browsing new e-mails included in a mailbox can be included. In this case, the user is probably browsing e-mails or the like in order of new reception mails or in order of arrival, and e-mail included in the same mailbox is predicted to be the information to be browsed next. The examples similar to this example include electronic bulletin boards.

### b) A Case of Browsing Information Linked to one Another

A typical example is viewing a website, and in a case of hyper text linking a sentence to a sentence, a page linked from the currently browsed page can be predicted as information to be browsed next.

### c) A Case of Browsing a Large Volume of Information Consecutively

An example is a case of browsing ling sentences and moving images, and in this case, since a direction that the user proceeds to browse can be easily known, the information that comes first on the time axis should sequentially become the predicated target.

Temporary Information Storage (Step S16)

The mobile phone 20 acquires information predicted in “user browsing information prediction” in step S14 from the server 10, and stores temporarily in the mobile phone 20 as cache. At that time, it is desirable that the temporary information is stored in highly volatile memory (RAM 23). At the time of storage, the information should be encrypted before storage in order to avoid information leakage in a case that the mobile phone 20 is lost by any chance.

User Browsing Continuation (Step S18)

When the user continues browsing, the processing shifts to “information browsing by user” in step S10 and repeats the processing from step S10 to step S18. Here, if the mobile phone 20 enters an out-of-service area in “information browsing by user” in step S10 and cannot communicate with the server 10, temporarily stored information (predicted information) is read out and browsed.

Complete Deletion of Temporary Information (Step S20)

When the user does not continue information browsing, the mobile phone 20 completely deletes the temporary information stored in the memory. As a result, the information acquired from the server 10 does not remain in the mobile phone 20, and therefore a risk of information leakage when the mobile phone is lost by any chance can be reduced.

FIG. 5 is a flowchart relating to deletion of temporary information by the information browsing system according to the presently disclosed subject matter. It should be noted that the operations of information browsing and out-of-service prediction described in FIG. 4 and operations of temporary information deletion described later are operating asynchronously.

There would be no problem if the temporary information deletion is implemented independently of the temporary information browsing. This is because the temporary information is deleted only in a situation when the mobile phone 20 would never enter out-of-service areas. If the information is deleted while a user is browsing the temporary information, the information can be acquired from the server 10 since the mobile phone 20 is in the service area.

Out-of-Service Prediction (Step S30)

In the same manner as step 12 described in FIG. 4, whether the mobile phone 20 possessed by the user soon enters an out-of-service area or not is predicted.

Service Area Settlement Confirmation (Step S32)

The mobile phone 20 confirms whether the mobile phone 20 is settled in the service area or not. For example, whether a certain time period has passed since the mobile phone 20 entered the service area or not is determined and if the time period has passed, the mobile phone 20 is regarded to be settled in the service area, and the processing shifts to “complete deletion of temporary information” (step S34). If the certain time period has not passed, the flow of the temporary information deletion is ended.

It should be noted that as a method for “out-of-service prediction” in step S30, the method of predicting whether the mobile phone 20 enters an out-of-service area or not based on a predicted moving location after a certain time period by obtaining a moving speed and a moving direction from the history of the GPS information is employed. If it is not predicted that the mobile phone 20 enters a service area and then enters an out-of-service area after a certain time period has passed, the processing can immediately shifts to “complete deletion of temporary information” (step S34).

Complete Deletion of Temporary Information (Step S34)

The mobile phone 20 completely deletes temporary information stored in RAM 23 as cache. As a result, the information acquired from the server 10 does not remain in the mobile phone 20, and therefore a risk of information leakage when the mobile phone is lost by any chance can be reduced.

### [Others]

It should be noted that in this embodiment, the map information indicating out-of-service area is stored in the mobile phone 20. However, the presently disclosed subject matter is not limited to this mode, but the map information can be stored in the server 10 side and the mobile phone 20 can acquire necessary map information from the server 10 in relation to the current location. In addition, the out-of-service area prediction device predicting whether the mobile phone 20 enters an out-of-service area or not is provided in the mobile phone side. However, the presently disclosed subject matter is not limited to this mode but the server 10 can predict whether the mobile phone 20 enters an out-of-service area or not by acquiring information of location information (GPS information and base station) of the mobile phone from the mobile phone or the mobile carrier. In this case, if a prediction is made that the mobile phone 20 enters the out-of-service area, the server 10 notifies the mobile phone 20 of the prediction.

Moreover, in this embodiment, the mobile phone 20 predicts information that the user is likely to browse next from the operations of the information that the user is browsing. However, this prediction can be made by server 10.

Furthermore, in this embodiment, a case of browsing information in the server 10 on the intra-company intranet is explained. However, the server 10 can be connected to other networks such as the Internet and the types of information to be browsed is not limited to information in the company but various types such as information in a website are applicable.

The presently disclosed subject matter is not limited to the above-described embodiment, but various modifications can be made without departing from the spirit of the invention.

What is claimed is:

1. An information browsing system including a server for storing information to be browsed with use of a mobile terminal and the mobile terminal for acquiring desired information from the stored information by communicating with the server, comprising:
an out-of-service area prediction device for predicting whether the mobile terminal will enter an out-of-service area;
a browsing information prediction device for predicting information that a user likely browse next after the out-of-service area prediction device predicts that the mobile terminal will enter an out-of-service area;
an information temporary storage device for acquiring the information predicted by the browsing information prediction device in advance from the server and for temporarily storing the information in the mobile terminal as a cache;
a browsing request instruction device for instructing a browse request for information that the user is likely to browse;
an information acquisition device for acquiring information corresponding to the browse request from the server if the mobile terminal is located in a service area when the browsing request information device issues the browse request, and for acquiring the information corresponding to the browse request from the information temporary storage device if the mobile terminal is located in an out-of-service area;
a display device for displaying the information acquired by the information acquisition device; and
a temporary information deletion device for deleting the information stored in the information temporary storage device when the mobile terminal enters a service area after the information is stored in the information temporary storage device and the out-of-service area prediction device does not predict that the mobile terminal will enter an out-of-service area.

2. The information browsing system of claim 1 wherein
the temporary information deletion device deletes the information stored in the information temporary storage device when the out-of-service area prediction device predicts that the mobile terminal is located in a service area for a prescribed time period or longer.

3. The information browsing system of claim 1, wherein
the temporary information deletion device preferentially deletes information that a user has browsed when deleting the information stored in the information temporary storage device.

4. The information browsing system of claim 1, wherein
the mobile terminal is a mobile phone and communicates with the server via a mobile phone network.

5. The information browsing system of claim 1, wherein
the mobile terminal communicates with the server via a wireless LAN.

6. The information browsing system of claim 1, wherein
the information browsed with use of the mobile terminal is an e-mail, information in a website, or information in an electronic bulletin board.

7. The information browsing system of claim 1, wherein
the mobile terminal includes a location information acquisition device for acquiring a location of the mobile terminal, and
the out-of-service area prediction device includes a map information storage device for storing map information indicating an out-of-service area, and predicts whether the mobile terminal will enter an out-of-service area on the basis of history of the location information acquired by the location information acquisition device and the map information stored in the map information storage device.

8. The information browsing system of claim 1, wherein
the out-of-service area prediction device includes a base station location acquisition device for acquiring a location of a base station used when the mobile terminal communicates with a server, and predicts whether the mobile terminal will enter an out-of-service area on the basis of the location of the base station acquired by the base station location acquisition device.

9. The information browsing system of claim 1, wherein
the out-of-service area prediction device predicts that the mobile terminal will enter an out-of-service area when radio field intensity falls below a preset threshold when the mobile terminal communicates with a server, or when a time period in which the radio field intensity remains below the preset threshold exceeds a certain time period.

10. The information browsing system of claim 1, wherein
the browsing information prediction device predicts information stored in parallel with information that a user is browsing.

11. The information browsing system of claim 1, wherein
the browsing information prediction device predicts information connected to information that a user is browsing.
